(19) United States
(12) Patent Application Publication
(10) Pub. No.: US 2002/0056929 A1
(43) Pub. Date: May 16, 2002

(54) Method and apparatus for applying lens sheet forming resin

(76) Inventor: Kazuyuki Matsumoto, Tokyo-to (JP)

Correspondence Address: LADAS & PARRY, 224 SOUTH MICHIGAN AVENUE, SUITE 1200, CHICAGO, IL, 60604, US

(21) Appl. No.: 09/973,517

(22) Filed: Oct. 9, 2001

(30) Foreign Application Priority Data
Nov. 14, 2000 (JP) P2000-346849

(51) Int. Cl. B29D 11/00

(52) U.S. Cl. 264/1.32; 264/1.34; 264/1.36; 264/1.7; 425/130; 425/808

(57) ABSTRACT

A method for applying resin for forming a lens sheet comprises the steps (a) to (c). The step (a) is to apply ionizing radiation curing type resin in a form of liquid on an entirety of an upper surface of a forming die through a multiple nozzle to form a first uncured resin layer on the upper surface of the forming die. The step (b) is to apply the ionizing radiation curing type resin in the form of liquid on one side of the first uncured resin layer through a nozzle to form an uncured resin pool thereon. The step (c) is to spread the uncured resin pool from the one side of the first uncured resin layer toward the other side thereof to form a second uncured resin layer on the first uncured resin layer.

### BACKGROUND OF THE INVENTION

1. Field of the Invention

The present invention relates a method and an apparatus for applying resin for forming a lens sheet, which are suitable to manufacture of the lens sheets such as Fresnel lens sheets

2. Description of the Related Art

Japanese Laid-Open Patent Application Nos. S64-86102, H6-67002 and H7-148751 disclose a method for applying resin for forming a lens sheet, which is applied to manufacture of various kinds of lens sheet such as Fresnel lens sheets, lenticular lens sheets or the like, which are to be used for a transmission type screen for a projection TV.

The method for applying resin for forming a lens sheet, which is disclosed in Japanese Laid-Open Patent Application No. S64-86102, comprises the steps of (i) applying ultraviolet ray curing type resin in the form of liquid on the entirety of the upper surface of a forming die by a silk screen process to form an uncured resin layer, (ii) applying the ultraviolet ray curing type resin in the form of liquid on one side of the uncured resin layer by a flow coating process to form an uncured resin pool, and (iii) applying pressure to the forming die from the above-mentioned one side toward the other side to flatten the uncured resin pool.

The method for applying resin for forming a lens sheet, which is disclosed in Japanese Laid-Open Patent Application No. H6-67002, comprises the steps of (i) applying ultraviolet ray curing type resin in the form of liquid on the entirety of the upper surface of a forming die through a nozzle having a plurality of holes to form an uncured resin layer, (ii) curing the uncured resin layer through radiation of ultraviolet ray to form a cured resin layer, (iii) applying the ultraviolet ray curing type resin in the form of liquid on one side of the cured resin layer through a nozzle having a plurality of holes to form an uncured resin pool and (iv) applying pressure to the forming die from the above-mentioned one side toward the other side to flatten the uncured resin pool.

The method for applying resin for forming a lens sheet, which is disclosed in Japanese Laid-Open Patent Application No. H7-148751, comprises the steps of (i) applying ultraviolet ray curing type resin in the form of liquid on one side of the upper surface of a forming die through a nozzle to form an uncured resin pool, (ii) spreading the uncured resin pool over the entirety of the upper surface of the forming die by a squeezing process, (iii) vaporizing solvent contained in the ultraviolet ray curing type resin by a hot-air dryer to form a solvent-vaporized layer, (iv) applying the ultraviolet ray curing type resin on one side of the solvent-vaporized layer through the other nozzle to form an uncured resin pool and (iv) applying pressure to the forming die from the above-mentioned one side toward the other side to flatten the uncured resin pool.

However, the above-mentioned prior art has a problem that a relatively large amount of bubbles is entrapped in lens formation grooves of the forming die and also included in ionizing radiation curing type resin applied on the forming die.

### SUMMARY OF THE INVENTION

An object of the present invention is therefore to provide a method and an apparatus for applying resin for forming a lens sheet, which permits to reduce an amount of bubbles, which are entrapped in lens formation grooves of a forming die and included in ionizing radiation curing type resin applied on the forming die, in comparison with the conventional method and apparatus.

In order to attain the aforementioned object, the method of the first aspect of the present invention for applying resin for forming a lens sheet comprises the steps of:

(a) applying ionizing radiation curing type resin in a form of liquid on an entirety of an upper surface of a forming die through a multiple nozzle to form a first uncured resin layer on the upper surface of said forming die;

(b) applying the ionizing radiation curing type resin in the form of liquid on one side of said first uncured resin layer through a nozzle to form an uncured resin pool thereon; and

(c) spreading said uncured resin pool from said one side of said first uncured resin layer toward an other side thereof to form a second uncured resin layer on said first uncured resin layer.

According to the feature of the first aspect of the method of the present invention, the ionizing radiation curing type liquid resin is poured in the form of threads from the multiple nozzle so as to be in a line in the transverse direction of the forming die to drop thereon. As a result, bubbles are not easily entrapped in lens formation grooves of the forming die, when applying the ionizing radiation curing type resin on the forming die. In addition, the uncured resin pool is spread on the first uncured resin layer, which has already been applied prior to application of the ionizing radiation curing type to form the uncured resin pool. It is therefore possible to prevent effectively bubbles from being entrapped in the lens formation grooves.

In the second aspect of the method of the present invention, a multiple nozzle may be used as the nozzle in the step (b). According to such a feature, it is possible to form rapidly the uncured resin pool on the one side of the first uncured resin layer without generation of bubbles between the uncured resin pool and the first uncured resin layer.

In the third aspect of the method of the present invention, the ionizing radiation curing type resin in the form of liquid may be subjected to a step for adjusting temperature of the ionizing radiation curing type resin to a prescribed temperature, which is suitable to formation of a lens sheet, prior to application thereof. According to such a feature, the temperature of the ionizing radiation curing type resin is previously adjusted in view of the prescribed temperature, which is suitable to formation of a lens sheet. It is therefore possible to smoothly pour the ionizing radiation curing type resin into the lens formation grooves so as to prevent bubbles from being entrapped in the lens formation grooves.

In the fourth aspect of the method of the present invention, the forming die may be subjected to a step for adjusting temperature of the forming die to a prescribed temperature, which is suitable to formation of a lens sheet. According to such a feature, the temperature of the forming die is previously adjusted in view of the prescribed temperature, which is suitable to formation of a lens sheet. It is therefore possible to more smoothly pour the ionizing radiation curing type resin into the lens formation grooves so as to prevent bubbles from being entrapped in the lens formation grooves, in cooperation with the temperature adjustment of the ionizing radiation curing type resin.

In order to attain the aforementioned object, the apparatus of the fifth aspect of the present invention for applying resin for forming a lens sheet comprises:

a first nozzle for applying ionizing radiation curing type resin in a form of liquid on an entirety of an upper surface of a forming die to form a first uncured resin layer on the upper surface of said forming die; and

a second nozzle for applying the ionizing radiation curing type resin in the from of liquid on one side of said first uncured resin layer to form an uncured resin pool thereon.

According to the feature of the fifth aspect of the apparatus of the present invention, the uncured resin pool, which is provided by applying the ionizing radiation curing type resin on the one side of the first uncured resin layer with the use of the second nozzle, is spread on the first uncured resin layer, which has already been applied with the use of the first nozzle, prior to application of the ionizing radiation curing type to form the uncured resin pool. It is therefore possible to prevent effectively bubbles from being entrapped in the lens formation grooves.

In the sixth aspect of the apparatus of the present invention, at least one of the first nozzle and the second nozzle may be a multiple nozzle. According to such a feature, the ionizing radiation curing type liquid resin is poured in the form of threads from the multiple nozzle so as to be in a line in the transverse direction of the forming die to drop thereon. As a result, it is possible to apply the ionizing radiation curing type resin on the forming die without bubbles entrapped in lens formation grooves of the forming die.

The apparatus of the seventh aspect of the present invention may further comprise a temperature-adjusting device for adjusting temperature of the ionizing radiation curing type resin to a prescribed temperature, which is suitable to formation of a lens sheet, prior to application thereof. According to such a feature, the temperature of the ionizing radiation curing type resin is previously adjusted in view of the prescribed temperature, which is suitable to formation of a lens sheet. It is therefore possible to smoothly pour the ionizing radiation curing type resin into the lens formation grooves so as to prevent bubbles from being entrapped in the lens formation grooves.

In the eighth aspect of the apparatus of the present invention, the multiple nozzle may be provided with a plurality of nozzle pipes, which project toward the forming die. According to such a feature, the nozzle pipes serves as nozzle holes. As a result, it is possible to ensure a uniform flaw rate of the ionizing radiation curing type resin poured from the nozzle holes so as to form the first uncured resin layer on the upper surface of the forming die in a prescribed constant thickness.

The apparatus of the ninth aspect of the present invention may further comprise a displacement type-single eccentric shaft screw pump for supplying the ionizing radiation curing type resin. According to such a feature, it is possible to supply the ionizing radiation curing type resin to the nozzle without applying shearing force due to a cutting or chafing action to the ionizing radiation curing type resin. As a result, the ionizing radiation curing type resin can be supplied onto the forming die without causing deterioration of the resin.

In the tenth aspect of the apparatus of the present invention, the multiple nozzle may have a device for adjusting an application width. According to such a feature, it is possible to apply the ionizing radiation curing type resin on the forming die in conformity to the width of the forming die, thus preventing waste of the ionizing radiation curing type resin.

In order to attain the aforementioned object, the apparatus of the eleventh aspect of the present invention for applying resin for forming a lens sheet comprises:

a nozzle for applying ionizing radiation curing type resin in a form of liquid on a forming die;

a moving device for moving said forming die below said nozzle; and

an application control device for controlling said moving device (i) to move said forming die from an original position thereof below said nozzle at a prescribed velocity so as to apply the ionizing radiation curing type resin in a form of liquid on an entirety of an upper surface of said forming die to form a first uncured resin layer on the upper surface of said forming die, then (ii) to return said forming die to said original position thereof and then (iii) to apply the ionizing radiation curing type resin in the form of liquid on one side of said first uncured resin layer to form an uncured resin pool thereon.

According to the feature of the eleventh aspect of the apparatus of the present invention, it is possible to apply two kinds of ionizing radiation curing type resin by means of a single nozzle. As a result, a small space can be conserved and the length of the application apparatus can be reduced.

### BRIEF DESCRIPTION OF THE DRAWINGS

FIGS. 1(A) to 1(G) are descriptive views illustrating steps of a lens sheet manufacturing method in sequence, to which a method of the present invention for applying resin for forming a lens sheet is applied;

FIG. 2(A) and 2(B) are plan views of a lens sheet manufactured by the lens sheet manufacturing method as shown in FIG. 1;

FIG. 3 is a plan view of a forming die;

FIG. 4 is a cross-sectional view cut along the line IV-IV in FIG. 3;

FIG. 5 is an elevation view illustrating a lens sheet manufacturing apparatus to which an apparatus of the present invention for applying resin for forming a lens sheet is applied;

FIG. 6 is a descriptive view of the lens sheet manufacturing apparatus, having a viewing direction based on the line IV-IV in FIG. 5;

FIG. 7 is a cross-sectional view cut along the line VII-VII in FIG. 6; and

FIG. 8 is a view illustrating a piping system in a device for supplying ionizing radiation curing type resin;

FIG. 9 is a cross-sectional view illustrating a pump in the device for supplying the ionizing radiation curing type resin;

FIG. 10 is a front view of a substrate-supplying device, having a viewing direction based on the line X-X in FIG. 5;

FIG. 11 is a view illustrating a piping system in a device for supplying ionizing radiation curing type resin in the second embodiment of the present invention; and

FIG. 12 is a view illustrating arrangements of the nozzles in the second embodiment of the present invention.

### DETAILED DESCRIPTION OF THE PREFERRED EMBODIMENTS

Now, embodiments of the present invention will be described in detail below with reference to the accompanying drawings.

<First Embodiment>

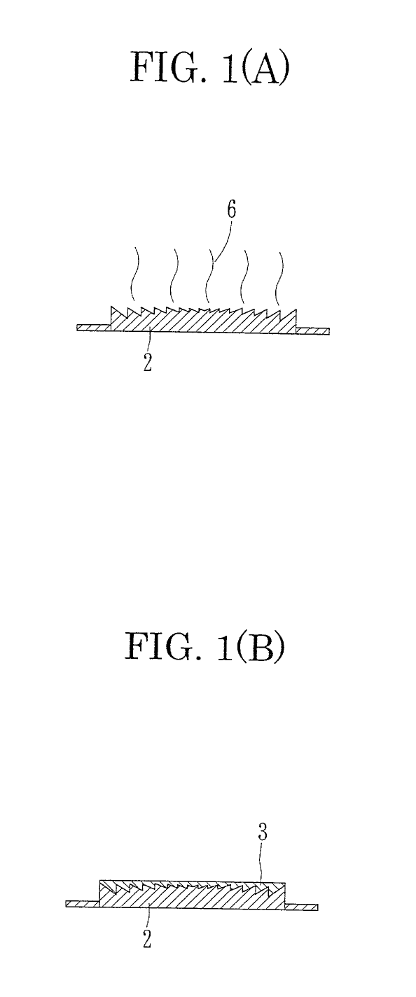

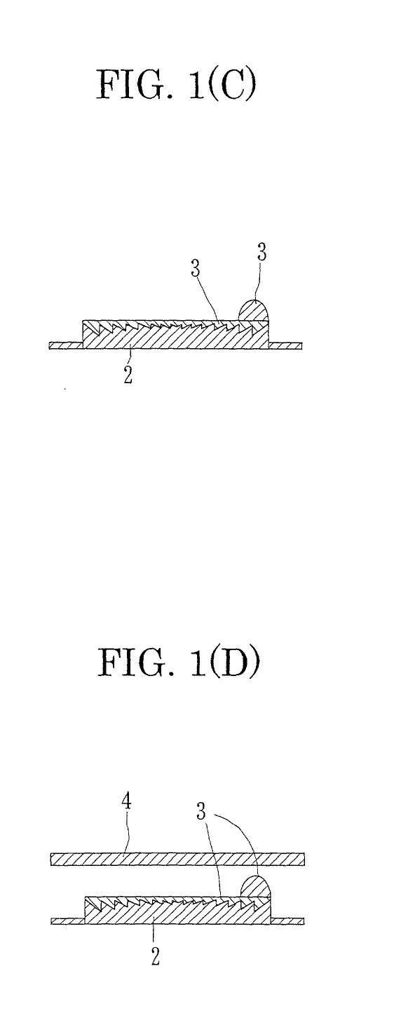

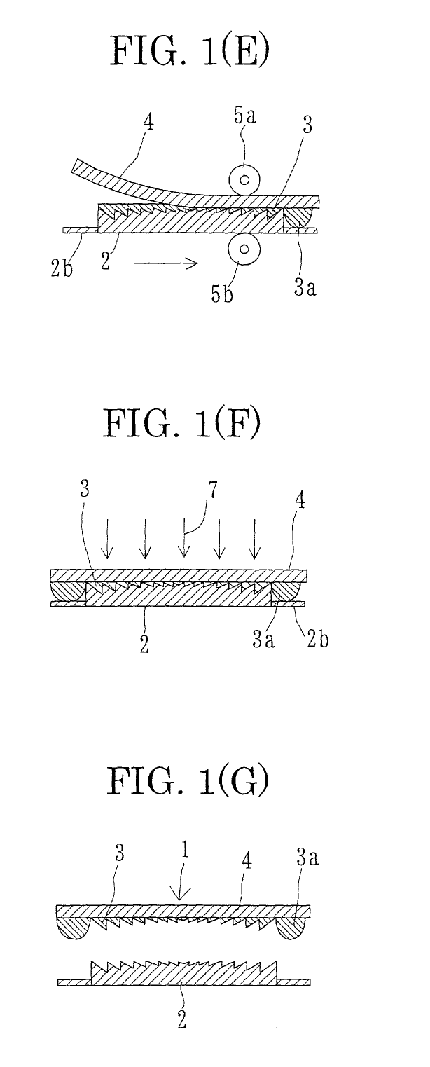

The method of the present invention for applying resin for forming a lens sheet is applied to a lens sheet manufacturing method as shown in FIG. 1. The lens sheet 1 is a Fresnel lens sheet. The application method of the present invention may be applied not only to the manufacture of the Fresnel lens sheet, but also to the manufacture of a lenticular lens sheet or the like.

As shown in FIGS. 1(A) to 1(G), the lens sheet 1 is manufactured by carrying out a temperature adjusting step (A) for make adjustment of temperature of a forming die 2 for the lens sheet 1 to a prescribed temperature, which is suitable to formation of the lens sheet 1; the first resin-application step (B) for applying ionizing radiation curing type resin 3 in the form of liquid, temperature of which has been adjusted to a prescribed temperature suitable to the formation of the lens sheet 1, on the entirety of the upper surface of the forming die 2, to which the above-mentioned temperature adjusting step (A) has been applied, to form the first uncured resin layer; the second resin-application step (C) for applying the ionizing radiation curing type resin 3 in the form of liquid, temperature of which has also adjusted to the prescribed temperature suitable to the formation of the lens sheet 1, on one side, i.e., a pressing-starting side (i.e., a spreading-starting side) of the first uncured layer, which has been applied on the forming die 2, to form an uncured resin pool; a substrate supplying step (D) for placing a substrate 4, through which ionizing radiation permeates, on the first uncured resin layer and the uncured resin pool from above the forming die 2; a laminating step (E) for pressing the substrate 4 and the forming die 2 from the pressing-starting side toward the pressing-finishing side by means of a pair of pressing rollers 5a, 5b to spread the uncured resin pool over the first uncured resin layer, thereby forming the second uncured resin layer on the first uncured resin layer; a resin-curing step (F) for irradiating ionizing radiation onto the first and second uncured resin layers through the substrate 4 to cure them; and a removing step (G) for removing the ionizing radiation curing type resin 3 as cured from the forming die 2 together with the substrate 4.

The forming die 2 used in the method of the present invention has a die body 2a, a receiving member 2b surrounding the periphery of the die body 2a and a base plate 2c having a disc-shape so as to surround the receiving member 2b. A cutting die, an electrocasting die, a resin die or the like may be used as the die body 2a. The receiving member 2b and the base plate 2c may be omitted, as an occasion demands. The die body 2a, which is a metallic die formed by for example an electrocasting method, has on its upper surface a lens formation surface on which ionizing radiation curing type resin is to be applied. The receiving member 2b, which projects outside from the four peripheral sides of the die body 2a, receives the superfluous amount of ionizing radiation curing type resin 3a overflowed from the die body 2. The base plate 2c supports the die body 2a and the receiving member from below thereof.

The temperature-adjusting step (A) is to heat uniformly the forming die 2 to a temperature, which is suitable to formation of the lens sheet. The step (A) is carried out for example by blowing hot air 6 heated by an electric heater, dried vapor or the like on the forming die 2 in a prescribed period of time. The blowing step of the hot air 6 may be applied uniformly to the entirety of the forming die 2, or in a manner that a flow rate of the hot air 6 is increased for a local portion, which is apt to be cooled. The flow rate of the hot air 6 can be adjusted by changing opening areas of a plurality of nozzles, while blowing the hot air 6 from these nozzles, or regulating an opening of a damper, which is provided on the upstream side of the nozzle. The temperature adjustment of the forming die 2 can also be made with the use of a temperature adjustment device disposed on the forming die 2.

In case where the ionizing radiation curing type resin 3 applied in accordance with the first resin-application step (B) and the second resin-application step (C) contains solvent, the above-described temperature-adjusting step (A) has functions not only of heating the forming die 2, but also of removing the solvent. Removal of the solvent from the ionizing radiation curing type resin 3 prevents bubbles from being entrapped in the lens. The forming die 2 may be heated excessively by ionizing radiation 7, which is irradiated in accordance with the resin-curing step (F). In such a case, the temperature adjusting step (A) makes it possible to cool the forming die 7 excessively heated to an optimum temperature.

The first resin-application step (B) is to apply the ionizing radiation curing type resin 3 in the form of liquid on the entirety of the upper surface of the forming die 2, to which the temperature-adjusting step (A) has been applied, to form the first uncured layer. In such a step (B), the ionizing radiation curing type resin 3 is poured in the form of liquid on the forming die 2 through a multiple nozzle. The multiple nozzle has a plurality of nozzle holes, which are in a line in the transverse direction of the forming die 2. Application of the ionizing radiation curing type resin 3 in the form of liquid is conducted, while one or both of the forming die 2 and the multiple nozzle is traveled. The ionizing radiation curing type liquid resin 3 is poured in the form of threads from the respective nozzle holes to drop on the forming die 2 so as to form a curtain of resin in the transverse direction of the forming die 2, i.e., the perpendicular direction to the traveling direction of the forming die 2. Accordingly, the ionizing radiation curing type resin 3 is applied on the forming die 2 without entrapping bubbles in lens formation grooves of the forming die 2.

Temperature of the ionizing radiation curing type resin 3 is previously adjusted to a temperature suitable to formation of the lens sheet. Such a temperature adjustment is conducted by heating the ionizing radiation curing type resin 3 by a heater or the like, prior to supply of the resin into the nozzle. The ionizing radiation curing type resin 3, which has already been subjected to the temperature adjustment, is poured from the multiple nozzle. As a result, the resin easily pours from the nozzle holes and smoothly flows into the lens formation grooves of the forming die 2 without entrapping bubbles in these grooves. The forming die 2 has also subjected to the temperature adjustment step to be heated uniformly. Accordingly, the ionizing radiation curing type liquid resin as applied rapidly extends over the lens formation grooves without entrapping bubbles.

Ultraviolet ray curing type resin, electron beam curing type resin or the like may be used as the ionizing radiation curing type liquid resin 3.

The second resin-application step (C) is to apply the ionizing radiation curing type liquid resin 3 on one side, i.e., the pressing-starting side of the first uncured layer, which has been applied on the forming die 2, to from an uncured resin pool on the pressing-starting side, i.e., the spreading-starting side). The ionizing radiation curing type liquid resin is poured on the forming die 2 through the same multiple nozzle as in the first resin-application step (B) or an ordinary single nozzle to form the uncured resin pool. The second resin-application step (C) may be omitted as an occasion demands. The ionizing radiation curing type resin 3 used for the first resin-application step (B) may be used as the resin for the second resin-application step (C) or different kind of resin may be used for the step (C). The resin used for the second resin-application step (C) is previously subjected to the temperature adjustment in view of a suitable temperature to formation of the lens sheet.

The substrate supplying step (D) is to place a substrate 4 on the first uncured resin layer and the uncured resin pool of the ionizing radiation curing type resin 3 from above the forming die 2. For example, a plurality of suction cups disposed on a plane suck the substrate 4 having a sheet-shape and are moved to carry the substrate 4 on the forming die 2 on which the first uncured resin layer and the uncured resin pool of the ionizing radiation curing type resin 3 have been formed. The sucking action of the suction cups is released so that the substrate 4 drops on the first uncured resin layer and the uncured resin pool of the ionizing radiation curing type resin 3, thus adhering on the surface of the ionizing radiation curing type resin 3.

The substrate 4 is formed of a transparent thin sheet such as an acrylic resin sheet through which ionizing radiation such as ultraviolet ray or electron beam permeates.

The laminating step (E) is to press the substrate 4 against the first uncured resin layer and the uncured resin pool of the ionizing radiation curing type resin 3 on the forming die 2 from the pressing-starting side, i.e., the spreading-starting side toward the pressing-finishing side, i.e., the spreading-finishing side. More specifically, the forming die 2 on which the first uncured resin layer and the uncured resin pool of the ionizing radiation curing type resin 3 have been formed and then the substrate 4 has been placed thereon, is passed between a pair of pressing rollers 5a, 5b to spread the uncured resin pool over the first uncured resin layer, so as to form the second uncured resin layer on the first uncured resin layer. As a result, the first uncured resin layer and the second uncured resin layer are combined into a united layer having a uniform thickness. The number of pair is not limited to one, and a plurality of pairs of pressing rollers may be provided. The uncured resin pool of the ionizing radiation curing type resin 3 applied in accordance with the second resin-application step (C) is spread over the first uncured resin layer from the pressing-starting side toward the pressing-finishing side so as to press bubbles out of the ionizing radiation curing type resin 3, thus preventing bubbles from being entrapped between the substrate 4 and the forming die 2. Of the pair of pressing rollers 5a, 5b, the upper roller 5a, which comes into contact with the substrate 4, is provided with a crown. Such a crown causes the ionizing radiation curing type resin 3 to flow smoothly into the lens formation grooves, which are formed concentrically, without entrapping bubbles in these grooves. In addition, the forming die 2 is previously subjected to the temperature adjustment in the laminating step (E). As a result, the ionizing radiation curing type resin 3 flows smoothly on the forming die 2, which is heated to an appropriate temperature, and comes securely in close contact with the substrate 4.

The resin-curing step (F) is to irradiate ionizing radiation onto the first and second uncured resin layers through the substrate 4 to cure them. More specifically, a radiation source such as an ultraviolet ray lamp is disposed above the forming die 2 to irradiate uniformly ionizing radiation 7 on the substrate 4. The ionizing radiation 7, which permeates through the substrate 4, acts on the ionizing radiation curing type resin 3 applied on the forming die to cure it. The ionizing radiation curing type resin 3 as cured adheres firmly to the substrate 4.

The removing step (G) is to removing the ionizing radiation curing type resin 3 as cured thorough irradiation of the ionizing radiation 7 from the forming die 2 together with the substrate 4. More specifically, manual operations will be carried out as follows. First, the central portion of the substrate 4 is urged against the forming die 2 and the opposite portions placed along a diagonal line of the lens sheet 1 are caught and lifted up. Accordingly, the ionizing radiation curing type resin 3 is peeled from the forming die 2 from the vicinities to the opposite portions toward the central portion. Then, the opposite portions placed along the diagonal line of the substrate 4 are moved down on the forming die 2. The other opposite portions placed along the other diagonal line of the substrate 4 are caught and lifted up. Accordingly, the ionizing radiation curing type resin 3 is peeled from the forming die 2 from the vicinities to the other opposite portions toward the central portion. Finally, all the two pairs of opposite portions are caught and lifted up simultaneously so that the whole ionizing radiation curing type resin 3 is completely peeled from the forming die 2.

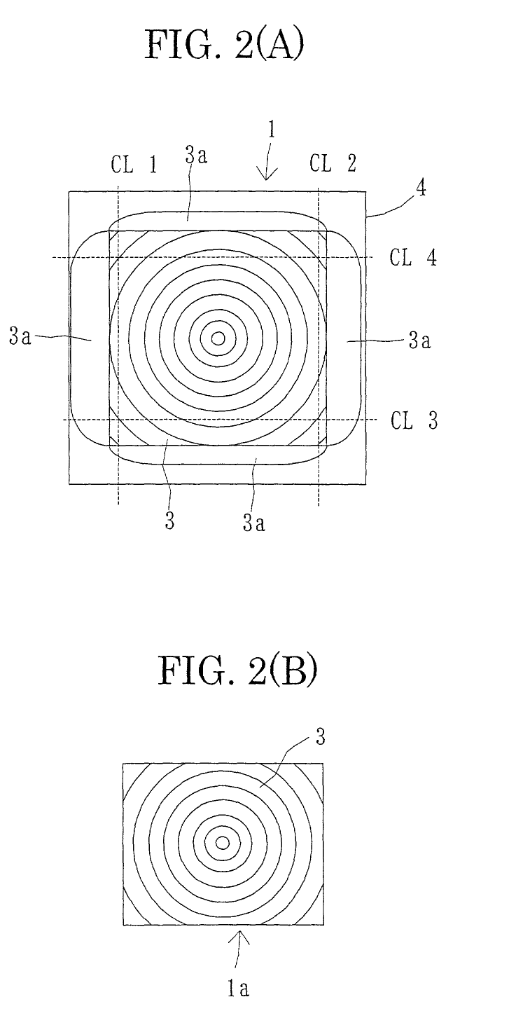

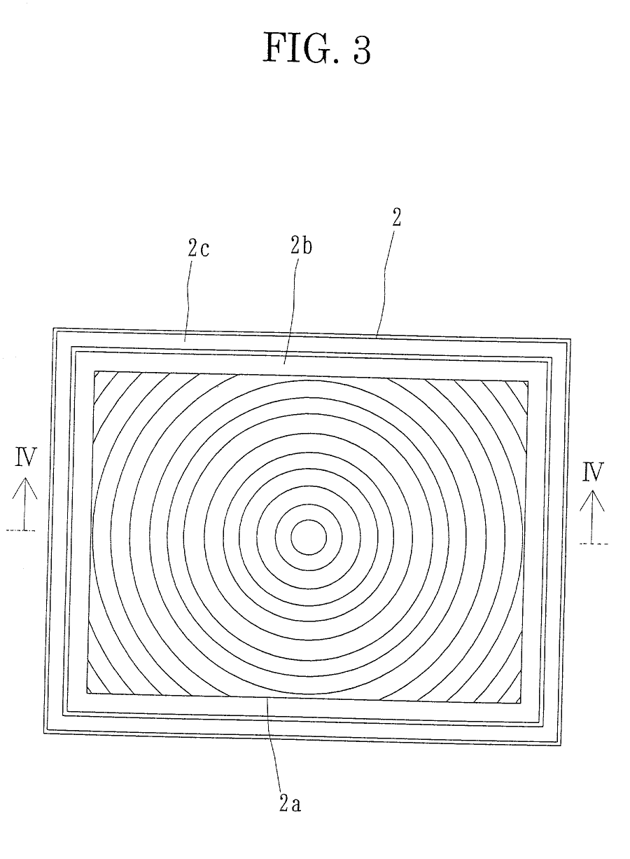

The Fresnel lens sheet 1 can be prepared by carrying out all of the steps (A) to (G). The substrate 4 of the Fresnel lens sheet 1 has a superfluous amount of ionizing radiation curing type resin 3, which has extended from the four sides of the forming die 2 to adhere on the substrate 4 and been cured, as shown in FIG. 2(A). Cutting operations of useless end portions having a superfluous amount of ionizing radiation curing type resin 3 are applied, as an occasion demands, to the Fresnel lens sheet 1 along cutting lines CL1, CL2, CL3 and CL4 as shown in FIG. 2(A) to remove the useless end portions, thus obtaining the Fresnel lens sheet la as the finished product.

Now, description will be given below of a manufacturing apparatus, which is applied to carry out the method for manufacturing the above-mentioned lens sheet.

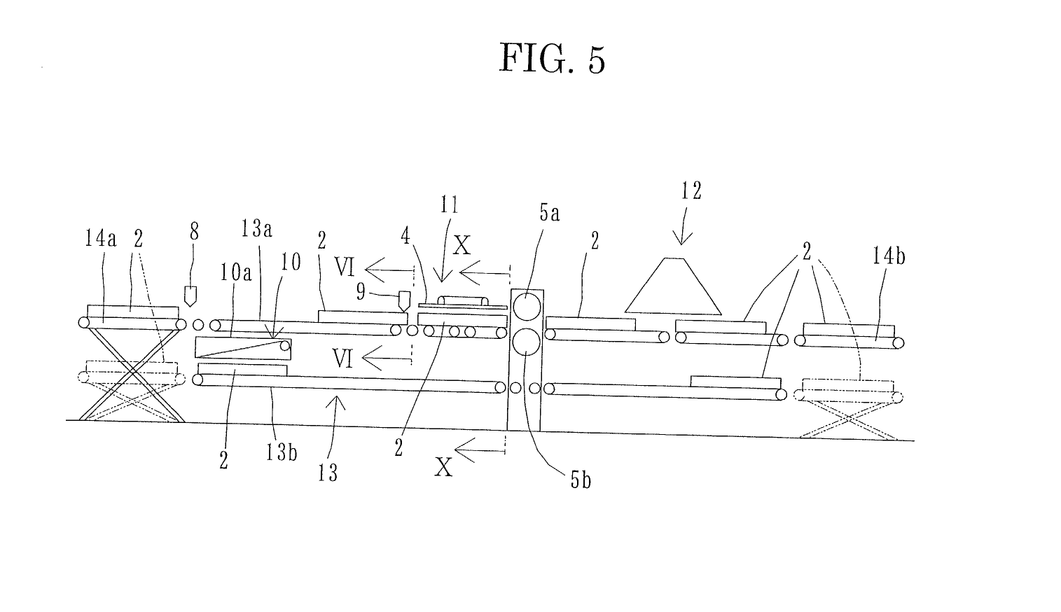

The apparatus for manufacturing a lens sheet includes, as shown in FIG. 5, a temperature adjusting device 10, the first nozzle 8, the second nozzle 9, a substrate supply device 11, a pair of pressing rollers 5a, 5b and an ionizing radiation irradiating device 12. The temperature-adjusting device 10 adjusts temperature of the forming die 2 for the lens sheet 1 to a suitable temperature for formation of the lens sheet. The first nozzle 8 is used to apply the ionizing radiation curing type resin in the form of liquid on the entirety of the upper surface of the forming die 2, the temperature of which has already been adjusted, to form the first uncured resin layer thereon. The second nozzle 9 is used to apply the ionizing radiation curing type resin in the form of liquid on a pressing-starting side, i.e., a spreading-starting side of the first uncured layer to form an uncured resin pool. The substrate supply device 11 places the substrate 4, through which ionizing radiation permeates, on the first uncured resin layer and the uncured resin pool from above the forming die 2. The pair of pressing rollers 5a, 5b presses the substrate 4 and the forming die 2 from the pressing-starting side toward the pressing-finishing side, i.e., the spreading-finishing side to spread the uncured resin pool over the first uncured resin layer, thereby forming the second uncured resin layer on the first uncured resin layer. The ionizing radiation irradiating device 12 irradiates ionizing radiation onto the first and second uncured resin layers of the ionizing radiation curing type resin 3 through the substrate 4 to cure them.

The apparatus for manufacturing a lens sheet has a conveying device 13 by which a plurality of forming dies 2 can be circulated therein. The conveying device 13 is provided on its upper side with a traveling passage 13a for the forming dies 2 and on its lower side with a returning passage 13b for them. The traveling passage 13a and the returning passage 13b are composed of a roller conveyer, a chain conveyer or the like. The conveying device 13 is provided on its opposite ends with lifters 14a, 14b. One lifter 14a has a function of moving the forming die 2, which has been returned on the returning passage 13b, upward to the traveling passage 13a. The other lifter 14b has a function of moving the forming die 2, which has been conveyed on the traveling passage 13a, downward to the returning passage 13b. The first and second nozzles 8, 9, the substrate supply device 11, the pressing rollers 5a, 5b and the ionizing radiation irradiating device 12 are disposed along the traveling passage 13a of the conveying device 13. The temperature-adjusting device 10 is disposed along the returning passage 13b of the conveying device 13. Each of the traveling passage 13a and the returning passage 13b of the conveying device 13 is divided into a plurality of endless conveying units, which can independently be driven at the respective independent speed or stopped in accordance with the steps carried out by the first and second nozzles 8, 9, the substrate supply device 11, the pressing rollers 5a, 5b and the ionizing radiation irradiating device 12.

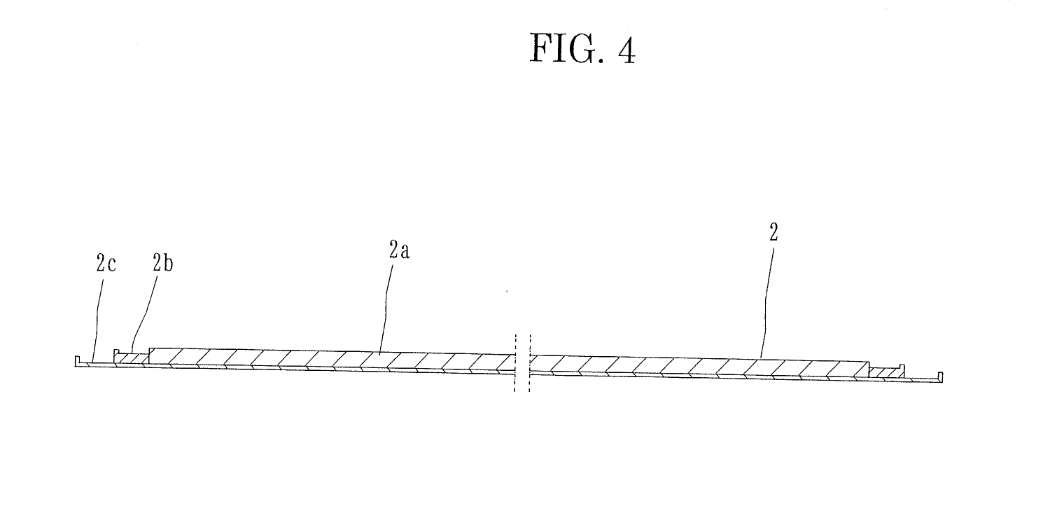

Dies having the structure as shown in FIGS. 3 and 4 are prepared as the forming die 2. These dies are disposed in a line on the conveying device 13.

The temperature-adjusting device 10 is provided on the returning passage 13b, and preferably in a connection position of the returning passage 13b with the lifter 14a for lifting the forming die 2. The temperature-adjusting device 10, which is provided on the returning passage 13b, provides a system in which temperature of the forming die 2 has been properly adjusted before the forming die 2 enters the inlet of the traveling passage 13a. This makes it possible to make a temperature adjustment of the forming die 2 during its non-service period of time, i.e., when the forming die 2 does not contribute to the formation of the lens sheet, thus preventing the length of the conveying device 13 for the forming dies 2 from being lengthen unnecessarily. The temperature-adjusting device 10 has a chamber 10a for surrounding the forming die 2, which stops once returning on the returning passage 13b. Dried vapor, hot air 6 heated by an electric heater or the like is supplied into the chamber 10a. The hot air 6, which is blown from the bottom of the chamber onto the forming die 2 heats it to a suitable temperature for formation of the lens sheet. The forming die 2 is kept in a stand-by state on the returning passage 13b until it is received by the lifter 14a for lifting the forming die 2. The forming die 2 is heated to a suitable temperature during such a stand-by state.

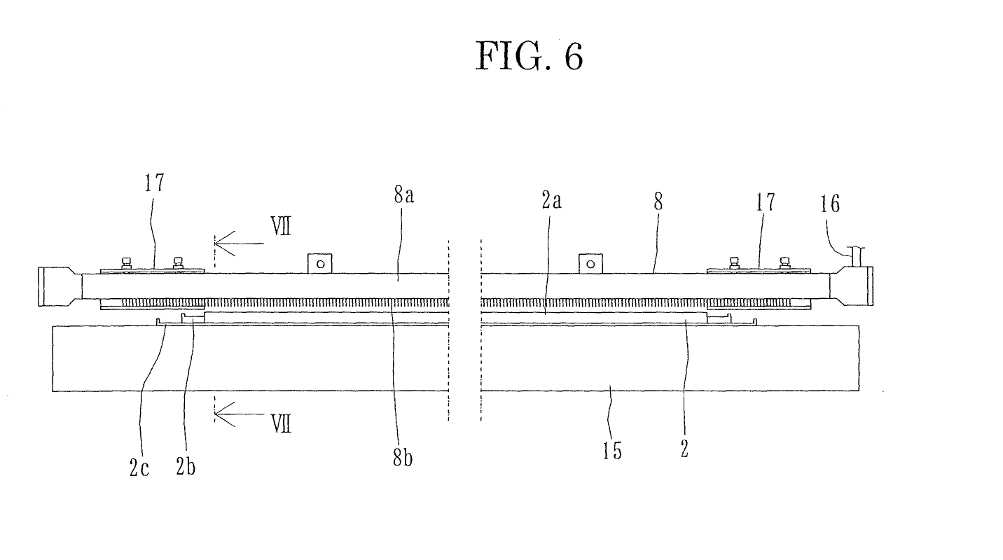

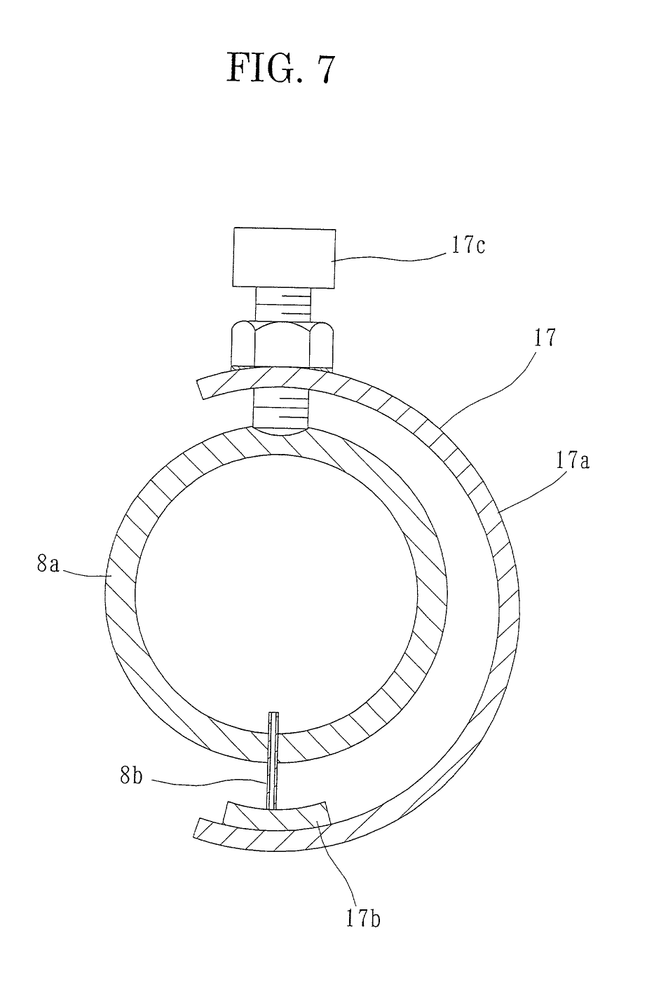

The first nozzle 8 is disposed on the inlet of the traveling passage 13a of the conveying device 13. More specifically, the first nozzle 8 is a multiple nozzle, which has a structure that a plurality of nozzle holes for pouring the ionizing radiation curing type liquid resin 3 onto the forming die 2 are provided in a line along the transverse direction of the forming die 2, as shown in FIGS. 6 and 7. The reference numeral “15” in FIG. 6 denotes the conveyer roller of the traveling passage 13. The multiple nozzle 8 is provided with a main pipe 8a, which is disposed horizontally in the transverse direction of the traveling passage 13a, namely in a perpendicular direction to the traveling direction, and with a plurality of nozzle pipes 8b, which are disposed at regular intervals on a single line on the lower surface of the main pipe 8a. The main pipe 8a has the opposite closed ends. A supply conduit 19 for supplying the ionizing radiation curing type liquid resin is connected to a prescribed portion of the main pipe 8a. The nozzle pipes, which serve as nozzle holes, are formed of an elongated small-diameter pipe made of stainless steel and pass through the wall of the main pipe 8a and are secured thereto by means of press fitting. The ionizing radiation curing type liquid resin 3 supplied into the main pipe 8a is poured simultaneously from the tip ends of the nozzle pipes 8b, which are disposed in a line, and applied onto the forming die 2, which travels below the nozzle pipes 8b or stops traveling. The nozzle pipes 8b extends from the main pipes 8a in the form of an elongated small-diameter pipe, with the result that flow rate of the ionizing radiation curing type resin 3 poured from the nozzle holes can be made substantially constant, thus making it possible to apply the ionizing radiation curing type resin 3 in a prescribed thickness on the forming die 2.

There are normally prepared the plurality of forming dies 2 having the different dimensions in accordance with the size of the lens sheet 1 to be manufactured. There may however be prepared the first nozzle 8, which is used exclusively for the specific dimensions of the forming dies 2. Alternatively, a pair of adjusting devices 17 as shown in FIGS. 6 and 7 may be provided on the opposite sides of the main pine 8a so as to adjust an application width of the ionizing radiation curing type resin 3 in accordance with the width of the forming die 2. Each of the adjusting devices 17 includes a supporting plate 17a, which curves so as to partially surround the main pipe 8a, a closing plate 1 7b made of flexible material such as rubber, which is secured on the inner surface of the supporting plate 17a, and a set screw 17c for holding stationarily the supporting plate 17a on the main pipe 8a. The supporting plate 17a is fitted on the main pipe 8a so that the closing plate 17b comes into contact with the tip ends of the nozzle pipes 8b. In such a state, the setscrew 17c is tighten so that the tip end of the setscrew 17c is urged against the outer surface of the main pipe 8a. The supporting plate 17a is stationarily secured on the main pipe 8a so that the tip ends of the nozzle pipes 8b, which are located outside the forming die 2, are closed by the closing plate 17b, thereby adjusting an application width of the ionizing radiation cured type resin 3. Change in securing position of the adjusting device 17 on the main pipe 8a in an appropriate manner makes it possible to change the number of the nozzle pipes 8b, which are to be closed. However, there may previously be prepared the plurality of adjusting devices 17 having the different lengths to each other. In this case, selection of an appropriate one of these adjusting devices 17 makes it possible to change the number of the nozzle pipes 8b, which are to be closed, thereby adjusting an application width of the ionizing radiation cured type resin 3.

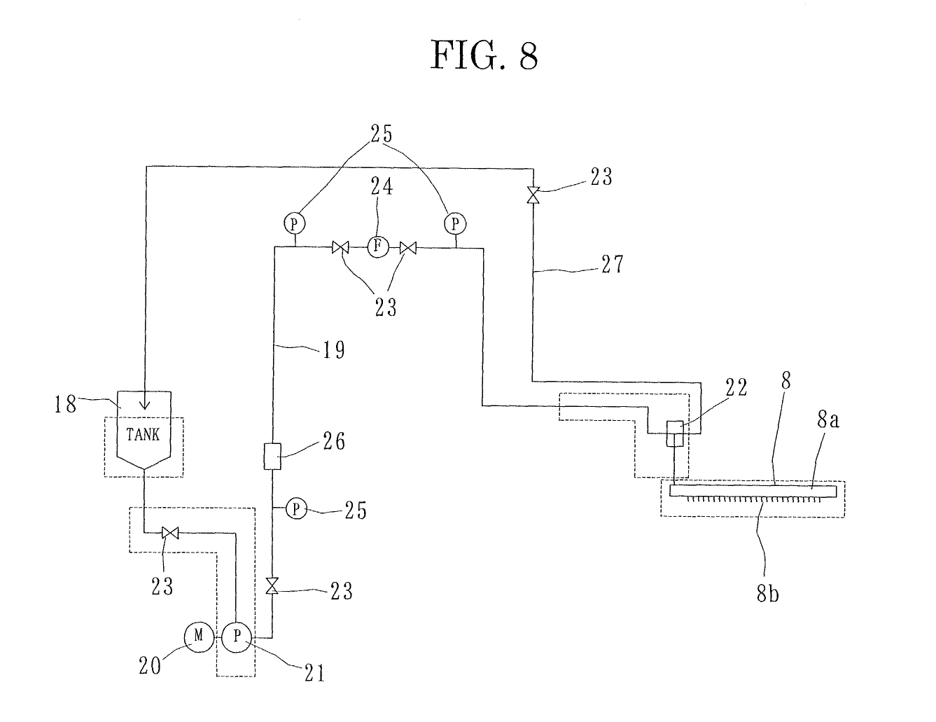

Supply of the ionizing radiation curing type liquid resin 3 into the first nozzle 8 is conducted by a piping as shown in FIG. 8. In FIG. 8, a reference numeral “18” denotes a reservoir tank 18 for the ionizing radiation curing type liquid resin 3. A supply conduit 19 for the ionizing radiation curing type liquid resin 3 extends from the reservoir tank 18 to the multiple nozzle 8. The supply conduit 19 is provided with a pump 21 driven by a gear motor 20, a discharge valve 22 serving as a three way valve for permitting connection of the source of the ionizing radiation curing type resin 3 with the first nozzle 8 to supply the resin 3 into the first nozzle or disconnection thereof, a manual valve 23, a filter 24, a pressure gauge 25, a flow meter 26 and the like. Driving of the pump 21 causes the ionizing radiation curing type resin 3 received in the reservoir tank 18 to flow in the supply conduit 19 toward the discharge valve 22. When the forming die 2 is moved in a prescribed position, the discharge valve 22 is opened so that the ionizing radiation curing type resin 3 flows into the main pipe 8a of the first nozzle 8. As a result, the ionizing radiation curing type resin 3 is poured onto the forming die 2. A return conduit 27 extends from the discharge valve 22 to the reservoir tank 18. In a state where the resin is not poured, the discharge valve 22 closes the supply conduit 19 communicating with the first nozzle 8 and simultaneously connects the supply conduit 19 to the return conduit 27. Accordingly, the ionizing radiation curing type resin flowing in the supply conduit 19 passes through the return conduit 27 and returns into the reservoir tank 18, thus performing circulation between the supply conduit 19 and the return conduit 27.

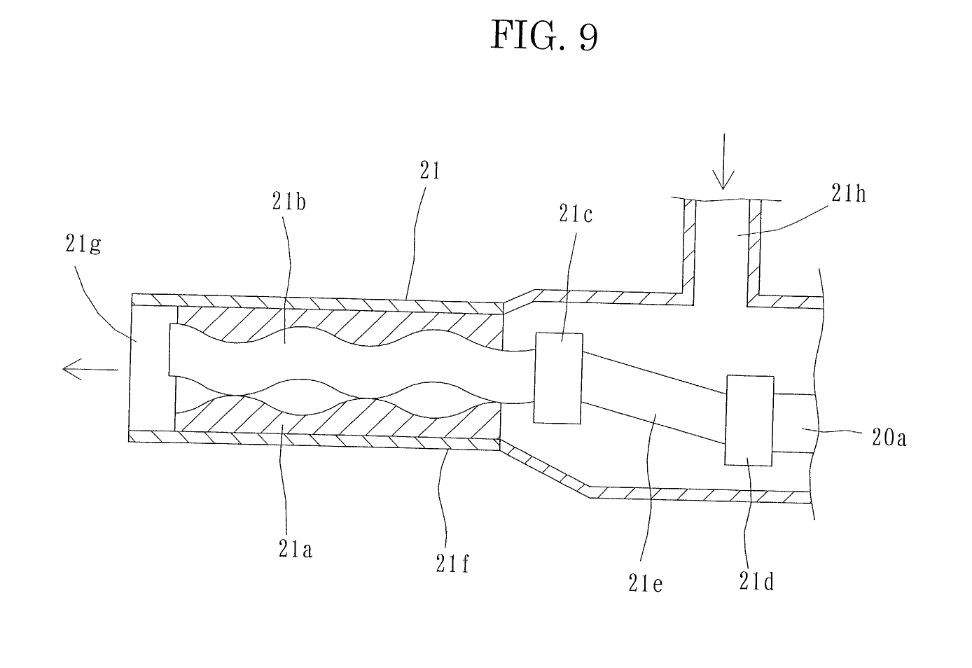

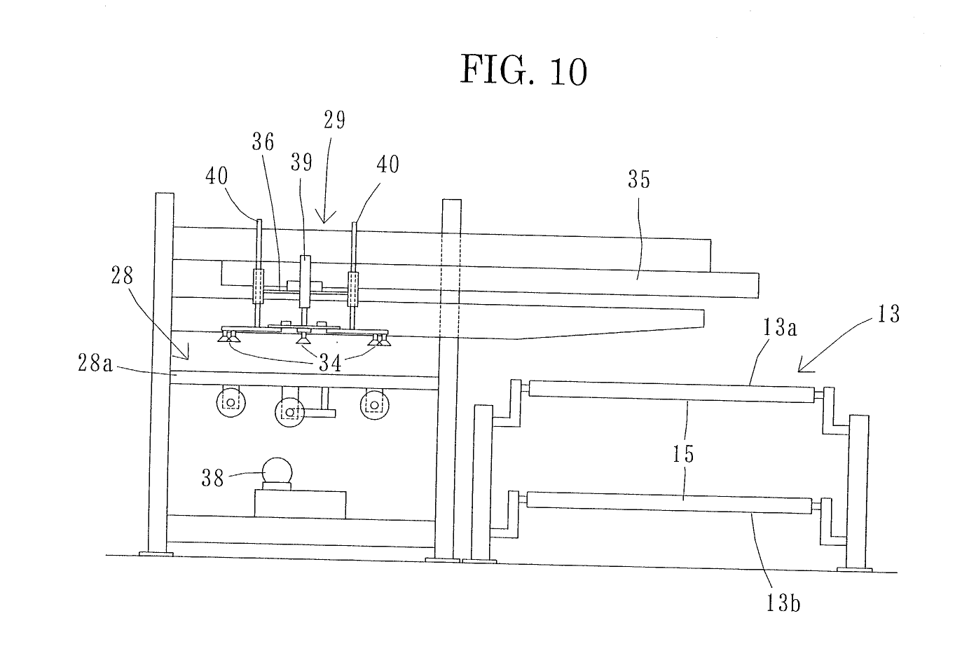

A displacement type-single eccentric shaft screw pump as shown in FIG. 9, which is so called “snake pump”, is used as the above-mentioned pump 21. The snake pump includes a stator 21 a, which is made of resilient material and has a central through-hole with a elliptic cross section, a spiral-shaped rotor 21b inserted into the stator 21a, two universal joints 21c, 21d provided between the rotor 21b and an output shaft 20a of a gear motor 20, and a coupling rod 21e. A housing 21f of the pump 21 is provided at its portion in which the stator 21a is received, with a discharge port 21g connected with the supply conduit 19. The housing 21f is provided at its portion in which the universal joints and the other structural components are received, with a suction port 21h. The ionizing radiation curing type resin 3 received in the reservoir tank 18 is sucked from the suction port 21h into the stator 21a and supplied from the discharge port 21g to the discharge valve 22. Pulsation does not easily occur in such a snake pump. Accordingly, the ionizing radiation curing type resin 3 can be discharged at a constant flow rate from the nozzle pipes 8b. The ionizing radiation curing type resin 3 can be applied on the forming die 2 to form the layer having a uniform thickness. The snake pump imparts almost no shearing force to the ionizing radiation curing type resin 3, thus permitting to apply the resin onto the forming die 2 without deterioration of the resin.

The ionizing radiation curing type liquid resin 3, temperature of which has already been adjusted, is applied on the entirety of the upper surface of the forming die 2 by the first nozzle 8.

The second nozzle 9 is provided on the downstream side of the multiple nozzle 8 on the traveling passage of the conveying device 13. The second nozzle 9 may have the same structure as the first nozzle 8. Supply of the ionizing radiation curing type resin to the second nozzle 9 may be performed by causing the conduit of the piping for the ionizing radiation curing type resin supplied to the first nozzle 8 to branch off.

The ionizing radiation curing type liquid resin is applied on the pressing-starting side of the first uncured layer, which has been applied on the forming die 2, to form an uncured resin pool.

The second nozzle 9 may be omitted, as an occasion demands. In such a case, there may be adopted an application system in which the ionizing radiation curing type resin 3 is applied onto the forming die 2 by the first nozzle 8 to form the first uncured layer, and then the forming die 2 is moved backward, and finally the ionizing radiation curing type resin 3 is applied on the one side of the first uncured layer to form an uncured resin pool. In such a case, the application apparatus includes, in addition to the first nozzle 8, a moving device for moving the forming die 2 below the first nozzle 8, and an application control device for controlling the moving device (i) to move the forming die 2 from an original position thereof below the nozzle 8 at a prescribed velocity so as to apply the ionizing radiation curing type resin 3 on the entirety of the upper surface of the forming die 2 to form the first uncured resin layer on the upper surface of the forming die 2, then (ii) to return the forming die 2 to the original position thereof and then (iii) to apply the ionizing radiation curing type resin on the one side of the first uncured resin layer to form an uncured resin pool thereon. The moving device is composed of the traveling passage 13a of the conveying device 13. The application control device controls the opening or closing the nozzle 8 and the normal traveling or reverse traveling of the traveling passage 13a of the conveying device 13 by detecting the position of the forming die 2 or the other structural components by means of a sensor (not shown).

Portions of the supply device for the ionizing radiation curing type resin, which are defined by dotted lines, are heated by heaters in the shape of ribbon. More specifically, heating the reservoir tank 18, the pump 21, the discharge valve 22 and the nozzle 8 in an appropriate manner cases the ionizing radiation curing type resin to be poured smoothly from the first and second nozzles 8, 9. In addition, subjecting the ionizing radiation curing type resin 3 and the forming die 2 to the respective temperature adjustments makes it possible to enhance formability of the ionizing radiation curing type resin 3.

The substrate supply device 11 is provided on the downstream side of the second nozzle 9 on the traveling passage 13a of the conveying device 13. The substrate supply device 11 includes a table 28 for making a positional determination of the substrate 4 and a substrate-conveying device 29, which moves reciprocally between the table 28 and the forming die 2 on the traveling passage 13a.

The positional determination table 28 is disposed along the one side of the conveying device 13 so that the one side of the table 28 extends in parallel to the traveling direction of the forming die 2. The positional determination table 28 is provided with a top board 28a having a horizontal plane on which the substrate 4 is placed. Three pins (not shown), which make a positional determination, project upward from the horizontal plane. The substrate 4 is placed on the positional determination table 28 one by one so that the adjacent two sides of the substrate 4 come into contact with the pins to make a positional determination. In such a state, extending lines of a pair of opposite sides of the substrate 4 coincide with the vertical plane including a pair of opposite sides of the forming die 2, which stops traveling on the conveying device 13.

The substrate-conveying device 29 includes a substrate-suction member and a moving member. The substrate-suction member has on its horizontal plane a plurality of suction cups 34. The moving member reciprocally moves the substrate-suction member between the positional determination table 28 and the forming die 2 on the traveling passage 13a of the conveying device 13. The moving member includes a rail 35, which extends from a position above the positional determination table 28 to the other position above the traveling passage 13a of the conveying device 13 in a direction perpendicular to the traveling direction of the forming die 2, an arm 36, which is capable of traveling on the rail 35, and a driving unit for driving the arm 36 on the rail 35. The driving unit is composed of a linear motor, an air cylinder or the like. The substrate-suction member has a plurality of suction cups 34. The suction cups 34 are connected to a vacuum pump 38. The substrate-suction member is connected to the front end of the arm 36 through the air cylinder 39 and a guide rod 40.

The substrate-suction member of the substrate-conveying device 29 moves up and down relative to the positional determination table 28 under operation of the air cylinder 39 so as to suck the substrate 4, which has been placed in a prescribed position on the positional determination table 28, and lift it up. The moving member of the substrate-conveying device 29 carries the substrate-suction member, by which the substrate 4 has been sucked, to a position just above the forming die 2, which temporarily stops traveling on the conveying device 13. Then, the air cylinder 38 is operated to move down the substrate-suction member toward the forming die 2 and then move it up. When the substrate-suction member descends toward the forming die 2, the suction of the substrate 4 is released so as to drop the substrate 4 onto the forming die 2. The substrate 4 is placed on the ionizing radiation curing type resin 3 applied on the forming die 2. Then, the substrate-suction member is carried again to the positional determination table 28 along the rail 35.

The pressing rollers 5a, 5b are disposed on the downstream side of the substrate supply device 11 on the traveling passage 13a of the conveying device 13. The pressing rollers 5a, 5b are disposed so that the traveling passage 13a is placed between the pressing rollers 5a, 5b in the vertical direction. The lower roller 5b, which comes into contact with the lower surface of the forming die 2, is formed of metal into a cylindrical shape. The upper roller 5a, which comes into contact with the substrate 4, which has been placed on the forming die 2, is provided with a crown. The upper roller 5a has a surface portion, which is made of resilient material such as rubber, to provide a cushioning property. The upper roller 5a is moved up and down by means of an air cylinder (not shown).

When the forming die 2 travels on the traveling passage 13a of the conveying device 13, the upper roller 5a descends under the function of the air cylinder so that the front portions of the forming die 2 and the substrate 4 are held between the upper roller 5a and the lower roller 5b. Both the upper and lower rollers 5a, 5b roll to move the forming die 2 in one direction. Accordingly, the ionizing radiation curing type resin 3 is spread through the substrate 4 so as to be flattened.

The ionizing radiation irradiating device 12, which is composed of a ultraviolet lamp or the like, is disposed on the downstream side of the pressing rollers 5a, 5b on the traveling passage 13a of the conveying device 13. Ionizing radiation 7, which is irradiated on the ionizing radiation curing type resin 3 through the substrate 4 from the ionizing radiation irradiating device 12, cures the ionizing radiation curing type resin 3. When the forming die 2 is carried on the filter 14b and stands in a non-moving state, the ionizing radiation curing type resin 3, which has been cured by irradiation of the ionizing radiation 7, is peeled from the forming die 2 by a manual operation.

Now, description will be given below of a series of operations of the above-described apparatus for manufacturing lens sheets.

Drive the conveying device 13 circulates the forming dies 2 in the apparatus for manufacturing lens sheets.

The temperature-adjusting device 10 carries out temperature adjustment of the forming die 2, which is out of an actual formation of the lens sheet and temporarily stops traveling before the returning lifter 14a.

The first nozzle 8 applies the ionizing radiation curing type resin in the form of liquid on the entirety of the upper surface of the forming die 2, which has been subjected to the temperature adjustment, to form the first uncured resin layer on the inlet portion of the traveling passage 13a of the conveying device 13.

The ionizing radiation curing type resin 3, which circulates in the piping, is poured from the nozzle holes, when the forming die 2 moves below the first nozzle 8 and the discharge valve 22 is opened. The forming die 2 travels at a constant speed below the first nozzle 8 so that the ionizing radiation curing type resin 3 is applied on the forming die 2 in a constant thickness.

The second nozzle 9 applies the ionizing radiation curing type resin 3 in the form of liquid on one side, i.e., the pressing-starting side of the first uncured layer formed on the forming die 2, on the downstream side of the first nozzle 8 to form an uncured resin pool on the first uncured layer. Application of the ionizing radiation curing type resin 3 through the second nozzle 9 is carried out after the operation of the traveling passage 13a of the conveying device 13 is temporarily stopped to keep the forming die 2 in a non-moving state.

The forming die 2 on which the first uncured layer and the uncured resin pool have been formed, is carried to a position of the substrate supply device 11 by the traveling passage 13a of the conveying device 13. The forming die 2 temporarily stops traveling immediately after it reaches to the above-mentioned position. The substrate-supply device 11 carries the substrate 4 above the forming die 2 and drops it thereon.

The position of the substrate 4 is previously determined on the positional determination table 28 so as to coincide with the position of the forming die 2.

After the substrate 4 is placed on the first uncured layer and the uncured resin pool of the ionizing radiation curing type resin 3, which have been applied on the forming die 2, the traveling passage 13a of the conveying device 13 carries the forming die 2 to the pressing rollers 5a, 5b. When the forming die 2 travels on the traveling passage 13a of the conveying device 13 to a prescribed position, the upper roller 5a descends so that the front portion, i.e., the pressing-starting end of the forming die 2 is held between the upper and lower rollers 5a, 5b. Both the upper and lower rollers 5a, 5b roll to move the forming die 2 in one direction. Accordingly, the uncured resin pool is spread on the first uncured layer through the substrate 4 to be flattened, thus forming the second uncured layer on the first resin layer. The first and second uncured layers are actually combined into a single united layer.

The traveling passage 13a of the conveying device 13 carries the forming die 2, which has passed between the pressing rollers 5a, 5b, to the ionizing radiation irradiating device 12. The forming die 2 passes be low the ionizing radiation irradiating device 12 . The forming die 3 may temporarily stop traveling below the ionizing radiation irradiating device 12. The ionizing radiation irradiating device 12 irradiates ionizing radiation 7 on the first and second layers of the ionizing radiation curing type resin 3 through the substrate 4 to cure them.

The traveling passage 13a of the conveying device 13 carries the forming die 2 on the lifter 14b. When the forming die 2 is carried on the filter 14b and stands in a non-moving state, the ionizing radiation curing type resin 3, which has been cured by irradiation of the ionizing radiation 7, i.e., a lens sheet as a semi-finished product is peeled from the forming die 2 by a manual operation.

Then, the forming die 2 from which the semi-finished product has been removed, is returned to a position of the temperature-adjusting device 10 by the operation of the returning passage 13b. The forming die 2 is then subjected to the temperature adjustment through the temperature-adjusting device 10 and then returned again to the traveling passage 13a so that it can be used for the next formation of the lens sheet.

<Second Embodiment>

In the first embodiment of the method and apparatus of the present invention for applying resin for forming a lens sheet, as typically shown in FIG. 1, the ionizing radiation curing type resin is applied on a single kind of forming die. However, in the second embodiment of the method and apparatus of the present invention, the ionizing radiation curing type resin is applied on two kinds of forming die, which have different dimensions in design or are made of different material from each other. Application conditions of the resin for forming the lens sheet, which depend on the kind of forming die 2, are automatically changed in accordance with the kind of the forming die 2.

The application conditions depending on the kind of forming die are as follows:

(1) for the first nozzle 8 in the first embodiment, for applying the ionizing radiation curing type resin 3 on the entirety of the upper surface of the forming die 2, an application width of the ionizing radiation curing type resin 3, an amount of resin poured, a pouring-starting position, a pouring-finishing position and a temperature adjustment of the nozzle;

(2) for the second nozzle 9 in the first embodiment, an application width of the ionizing radiation curing type resin 3, an amount of resin poured, a pouring position, and a temperature adjustment of the nozzle; and

(3) pressing force of the pressing rollers 5a, 5b, a pressing-starting position and a pressing-finishing position.

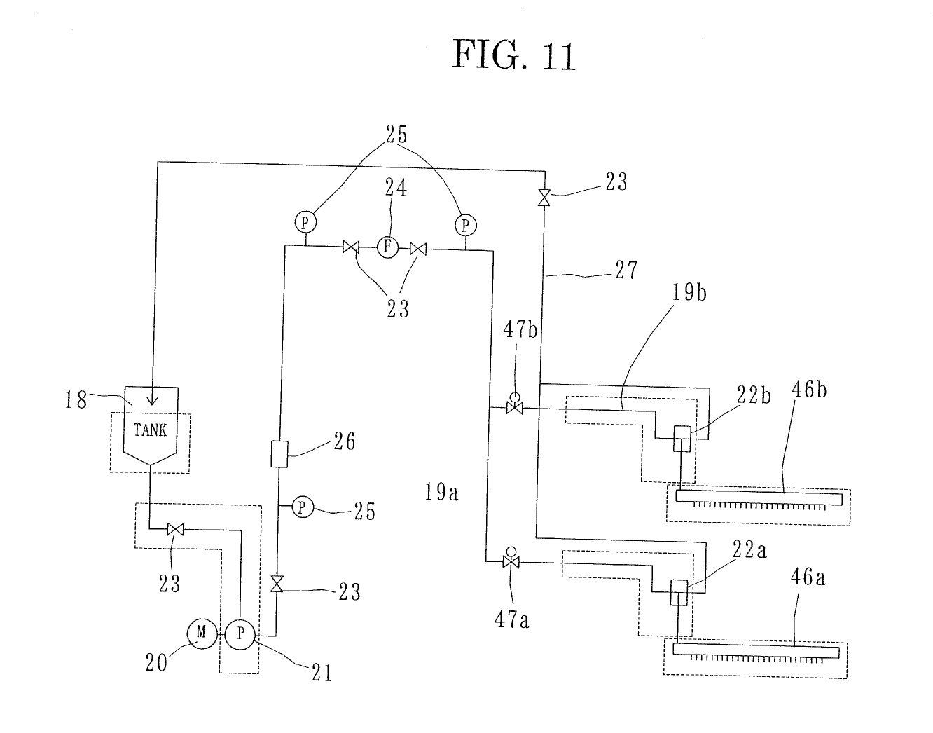

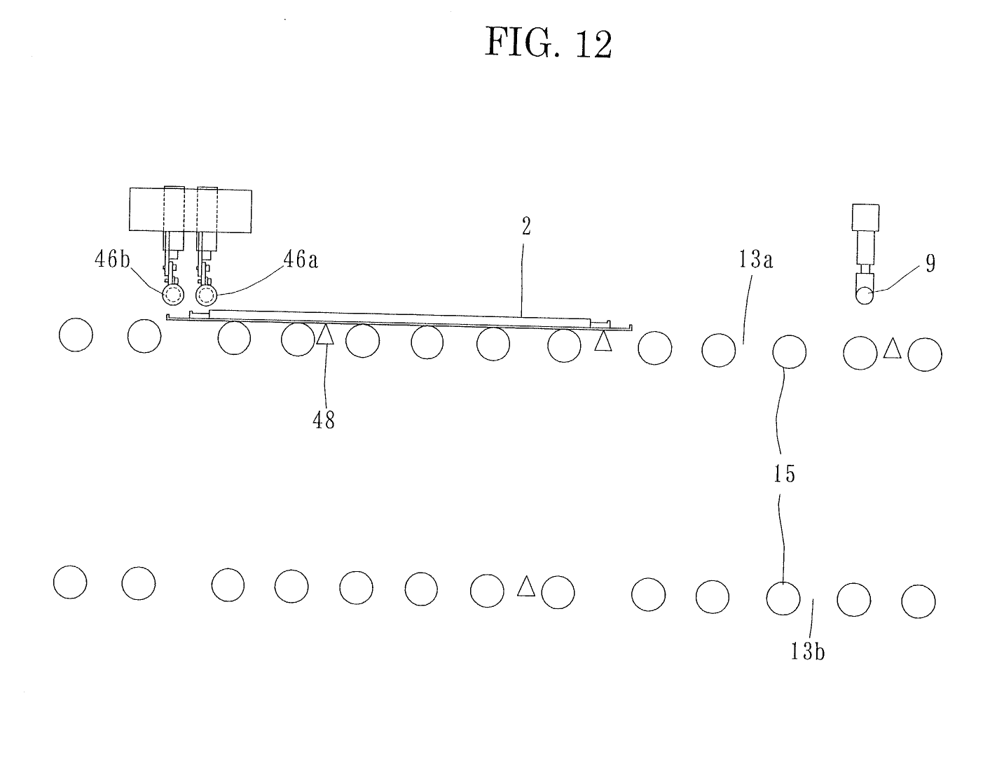

The application width listed in the items (1) and (2) above can be adjusted by arranging two kinds of first nozzle 46a, 46b on the traveling passage 13a of the conveying device 13 and providing the supply conduits 19a, 19b for supplying the ionizing radiation curing type resin 3 into the respective nozzles 46a, 46b with automatic valves 47a, 47b, respectively, as shown in FIGS. 11 and 12. The nozzles 46a, 46b correspond to the respective forming dies 2 and portions of the nozzle pipes 8b, which are not to be used taking into consideration the width of the forming die 2, are closed by means of the adjusting device 17.

The amount of resin poured listed in the items (1) and (2) can be adjusted by changing number of revolutions of the pump 21.

The pouring-starting position, the pouring-finishing position and the pouring position listed in the items (1) and (2) above can be adjusted by carrying out a switching operation of a timer (not shown).

The pressing force listed in the item (3) above can be adjusted by carrying out a switching operation of a pressure regulator (not shown).

The pressing-starting position and the pressing-finishing position listed in the item (3) can be adjusted by carrying out a switching operation of a timer (not shown).

Identification of two kinds of forming die 2 can be performed by a preset method or a sensing method. With respect to the sensing method, a metallic piece (not shown) is for example attached on the end surface of the base plate 2c of the forming die 2. Detecting existence of the metallic piece on the upstream side of the conveying device 13 with the use of a proximity sensor 48 performs identification of two kinds of forming die 2.

Detecting the existence of the metallic piece by means of the proximity sensor 48 causes one of the automatic valve 47a and 47b for the corresponding forming die to be opened and the other thereof to be closed so that the ionizing radiation curing type resin 3 is applied in an appropriate width through the corresponding first nozzle 46a or 46b. The number of revolutions of the pump 21 is adjusted to an appropriate one so as to change the amount of resin poured in a proper manner. In addition, the switching operation of the timer (not shown) is carried out so as to change the pouring-starting position and the pouring-finishing position in an appropriate manner. The switching operation of the pressure regulator (not shown) is also carried out so as to change the pressing force given by the pressing rollers 5a, 5b. The switching operation of the timer (not shown) is also carried out so as to change the pressing-starting position and the pressing-finishing position of the pressing rollers 5a, 5b.

It is therefore possible to manufacture two kinds of lens sheet, which have different dimensions from each other and are designed differently from each other, with the use of the same apparatus for manufacturing a lens sheet.

In the above-described embodiment, two kinds of forming die are used. The present invention may be applied to a case where three or more kinds of forming die are used.

According to the first aspect of the present invention as described in detail, the method for applying resin for forming a lens sheet comprises the steps of: (a) applying ionizing radiation curing type resin in a form of liquid on an entirety of an upper surface of a forming die through a multiple nozzle to form a first uncured resin layer on the upper surface of said forming die; (b) applying the ionizing radiation curing type resin in the form of liquid on one side of said first uncured resin layer through a nozzle to form an uncured resin pool thereon; and (c) spreading said uncured resin pool from said one side of said first uncured resin layer toward an other side thereof to form a second uncured resin layer on said first uncured resin layer. According to the feature of the first aspect of the method of the present invention, the ionizing radiation curing type liquid resin is poured in the form of threads from the multiple nozzle so as to be in a line in the transverse direction of the forming die to drop thereon. As a result, bubbles are not easily entrapped in lens formation grooves of the forming die, when applying the ionizing radiation curing type resin on the forming die. In addition, the uncured resin pool is spread on the first uncured resin layer, which has already been applied prior to application of the ionizing radiation curing type to form the uncured resin pool. It is therefore possible to prevent effectively bubbles from being entrapped in the lens formation grooves.

In the second aspect of the method of the present invention, a multiple nozzle may be used as the nozzle in the step (b). According to such a feature, it is possible to form rapidly the uncured resin pool on the one side of the first uncured resin layer without generation of bubbles between the uncured resin pool and the first uncured resin layer.

In the third aspect of the method of the present invention, the ionizing radiation curing type resin in the form of liquid may be subjected to a step for adjusting temperature of the ionizing radiation curing type resin to a prescribed temperature, which is suitable to formation of a lens sheet, prior to application thereof. According to such a feature, the temperature of the ionizing radiation curing type resin is previously adjusted in view of the prescribed temperature, which is suitable to formation of a lens sheet. It is therefore possible to smoothly pour the ionizing radiation curing type resin into the lens formation grooves so as to prevent bubbles from being entrapped in the lens formation grooves.

In the fourth aspect of the method of the present invention, the forming die may be subjected to a step for adjusting temperature of the forming die to a prescribed temperature, which is suitable to formation of a lens sheet. According to such a feature, the temperature of the forming die is previously adjusted in view of the prescribed temperature, which is suitable to formation of a lens sheet. It is therefore possible to more smoothly pour the ionizing radiation curing type resin into the lens formation grooves so as to prevent bubbles from being entrapped in the lens formation grooves, in cooperation with the temperature adjustment of the ionizing radiation curing type resin.

The apparatus of the fifth aspect of the present invention for applying resin for forming a lens sheet comprises: a first nozzle for applying ionizing radiation curing type resin in a form of liquid on an entirety of an upper surface of a forming die to form a first uncured resin layer on the upper surface of said forming die; and a second nozzle for applying the ionizing radiation curing type resin in the from of liquid on one side of said first uncured resin layer to form an uncured resin pool thereon. According to the feature of the fifth aspect of the apparatus of the present invention, the uncured resin pool, which is provided by applying the ionizing radiation curing type resin on the one side of the first uncured resin layer with the use of the second nozzle, is spread on the first uncured resin layer, which has already been applied with the use of the first nozzle, prior to application of the ionizing radiation curing type to form the uncured resin pool. It is therefore possible to prevent effectively bubbles from being entrapped in the lens formation grooves.

In the sixth aspect of the apparatus of the present invention, at least one of the first nozzle and the second nozzle may be a multiple nozzle. According to such a feature, the ionizing radiation curing type liquid resin is poured in the form of threads from the multiple nozzle so as to be in a line in the transverse direction of the forming die to drop thereon. As a result, it is possible to apply the ionizing radiation curing type resin on the forming die without bubbles entrapped in lens formation grooves of the forming die.

The apparatus of the seventh aspect of the present invention may further comprise a temperature-adjusting device for adjusting temperature of the ionizing radiation curing type resin to a prescribed temperature, which is suitable to formation of a lens sheet, prior to application thereof. According to such a feature, the temperature of the ionizing radiation curing type resin is previously adjusted in view of the prescribed temperature, which is suitable to formation of a lens sheet. It is therefore possible to smoothly pour the ionizing radiation curing type resin into the lens formation grooves so as to prevent bubbles from being entrapped in the lens formation grooves.

In the eighth aspect of the apparatus of the present invention, the multiple nozzle may be provided with a plurality of nozzle pipes, which project toward the forming die. According to such a feature, the nozzle pipes serves as nozzle holes. As a result, it is possible to ensure a uniform flaw rate of the ionizing radiation curing type resin poured from the nozzle holes so as to form the first uncured resin layer on the upper surface of the forming die in a prescribed constant thickness.

The apparatus of the ninth aspect of the present invention may further comprise a displacement type-single eccentric shaft screw pump for supplying the ionizing radiation curing type resin. According to such a feature, it is possible to supply the ionizing radiation curing type resin to the nozzle without applying shearing force due to a cutting or chafing action to the ionizing radiation curing type resin. As a result, the ionizing radiation curing type resin can be supplied onto the forming die without causing deterioration of the resin.

In the tenth aspect of the apparatus of the present invention, the multiple nozzle may have a device for adjusting an application width. According to such a feature, it is possible to apply the ionizing radiation curing type resin on the forming die in conformity to the width of the forming die, thus preventing waste of the ionizing radiation curing type resin.

The apparatus of the eleventh aspect of the present invention for applying resin for forming a lens sheet comprises: a nozzle for applying ionizing radiation curing type resin in a form of liquid on a forming die; a moving device for moving said forming die below said nozzle; and an application control device for controlling said moving device (i) to move said forming die from an original position thereof below said nozzle at a prescribed velocity so as to apply the ionizing radiation curing type resin in a form of liquid on an entirety of an upper surface of said forming die to form a first uncured resin layer on the upper surface of said forming die, then (ii) to return said forming die to said original position thereof and then (iii) to apply the ionizing radiation curing type resin in the form of liquid on one side of said first uncured resin layer to form an uncured resin pool thereon. According to the feature of the eleventh aspect of the apparatus of the present invention, it is possible to apply two kinds of ionizing radiation curing type resin by means of a single nozzle. As a result, a small space can be conserved and the length of the application apparatus can be reduced.

The entire disclosure of Japanese Patent Application No. 2000-346849 filed on Nov. 14, 2000 including the specification, claims, drawings and summary is incorporated herein by reference in its entirety.

What is claimed is:

1. A method for applying resin for forming a lens sheet, comprising the steps of:
(a) applying ionizing radiation curing type resin in a form of liquid on an entirety of an upper surface of a forming die through a multiple nozzle to form a first uncured resin layer on the upper surface of said forming die;
(b) applying the ionizing radiation curing type resin in the form of liquid on one side of said first uncured resin layer through a nozzle to form an uncured resin pool thereon; and
(c) spreading said uncured resin pool from said one side of said first uncured resin layer toward an other side thereof to form a second uncured resin layer on said first uncured resin layer.

2. The method as claimed in claim 1, wherein:
a multiple nozzle is used as said nozzle in said step (b).

3. The method as claimed in claim 1, wherein:
the ionizing radiation curing type resin in the form of liquid is subjected to a step for adjusting temperature of the ionizing radiation curing type resin to a prescribed temperature, which is suitable to formation of a lens sheet, prior to application thereof.

4. The method as claimed in claim 2, wherein:
the ionizing radiation curing type resin in the form of liquid is subjected to a step for adjusting temperature of the ionizing radiation curing type resin to a prescribed temperature, which is suitable to formation of a lens sheet, prior to application thereof.

5. The method as claimed in any one of claims 1 to 4, wherein:
the forming die is subjected to a step for adjusting temperature of the forming die to a prescribed temperature, which is suitable to formation of a lens sheet.

6. An apparatus for applying resin for forming a lens sheet, comprising:
a first nozzle for applying ionizing radiation curing type resin in a form of liquid on an entirety of an upper surface of a forming die to form a first uncured resin layer on the upper surface of said forming die; and
a second nozzle for applying the ionizing radiation curing type resin in the from of liquid on one side of said first uncured resin layer to form an uncured resin pool thereon.

7. The apparatus as claimed in claims 6, wherein:
at least one of said first nozzle and said second nozzle is a multiple nozzle.

8. The apparatus as claimed in claim 6, further comprising:
a temperature adjusting device for adjusting temperature of the ionizing radiation curing type resin to a prescribed temperature, which is suitable to formation of a lens sheet, prior to application thereof.

9. The apparatus as claimed in claim 7, further comprising:
a temperature adjusting device for adjusting temperature of the ionizing radiation curing type resin to a prescribed temperature, which is suitable to formation of a lens sheet, prior to application thereof.

10. The apparatus as claimed in any one of claims 7 to 9, wherein:
said multiple nozzle is provided with a plurality of nozzle pipes, said nozzle pipes projecting toward said forming die.

11. The apparatus as claimed in claim 6, further comprising:
a displacement type-single eccentric shaft screw pump for supplying the ionizing radiation curing type resin.

12. The apparatus as claimed in claim 7, further comprising:
a displacement type-single eccentric shaft screw pump for supplying the ionizing radiation curing type resin.

13. The apparatus as claimed in claim 8, further comprising:
a displacement type-single eccentric shaft screw pump for supplying the ionizing radiation curing type resin.

14. The apparatus as claimed in claim 9, further comprising:
a displacement type-single eccentric shaft screw pump for supplying the ionizing radiation curing type resin.

15. The apparatus as claimed in claim 10, further comprising:
a displacement type-single eccentric shaft screw pump for supplying the ionizing radiation curing type resin.

16. The apparatus as claimed in any one of claims 7 to 9, and 11 to 14, wherein:
said multiple nozzle has a device for adjusting an application width.

17. The apparatus as claimed in claim 10, wherein:
said multiple nozzle has a device for adjusting an application width.

18. The apparatus as claimed in claim 15, wherein:
said multiple nozzle has a device for adjusting an application width.

19. An apparatus for applying resin for forming a lens sheet, comprising:
a nozzle for applying ionizing radiation curing type resin in a form of liquid on a forming die;
a moving device for moving said forming die below said nozzle; and
an application control device for controlling said moving device (i) to move said forming die from an original position thereof below said nozzle at a prescribed velocity so as to apply the ionizing radiation curing type resin in a form of liquid on an entirety of an upper surface of said forming die to form a first uncured resin layer on the upper surface of said forming die, then (ii) to return said forming die to said original position thereof and then (iii) to apply the ionizing radiation curing type resin in the form of liquid on one side of said first uncured resin layer to form an uncured resin pool thereon.
